(19) United States
(12) Patent Application Publication
(10) Pub. No.: US 2013/0138983 A1
(43) Pub. Date: May 30, 2013

(54) AUTOMATED FEATURE CONTROL ON BATTERY LIMITED DEVICES

(71) Applicant: Stuart Ian Geary, Fleet (GB)

(72) Inventor: Stuart Ian Geary, Fleet (GB)

(73) Assignee: RENESAS MOBILE CORPORATION, Tokyo (JP)

(21) Appl. No.: 13/305,336

(22) Filed: Nov. 28, 2011

(30) Foreign Application Priority Data
Nov. 25, 2011 (GB) 1120397.3

(51) Int. Cl. G06F 1/32

(52) U.S. Cl. 713/320

(57) ABSTRACT

The present invention introduces a method for saving power in battery limited devices. The invention handles profile properties, which may e.g. be User Interface activity, Bluetooth connection success, email fetch success or WLAN connection success. A value of the property is saved into a memory, e.g. once an hour for the whole calendar week, thus forming a trend value which is regularly updated. Certain behavior patterns may then be seen. When changes in the trend occur with different users or as differences compared to a usual behavior in a calendar week, for instance, the characteristics of the device are altered accordingly in order to minimize power usage.

### CROSS REFERENCE TO RELATED APPLICATION

This application claims the benefit of and priority to United Kingdom patent application number 1120397.3, filed on Nov. 25, 2011.

### BACKGROUND OF THE INVENTION

1. Field of the Invention

The present invention relates to any battery limited device, for instance to mobile terminals providing feature control to a user, enabling the battery consumption to be controlled, and even minimized.

2. Description of the Related Art

There have been advances in mobile operating systems wherein the user can configure a profile for email which suits their usage. For example, the terminal may be configured to provide push email for 9 AM-5 PM on weekdays and then revert to infrequent polling outside of these time periods. This saves battery power and also reduces loading to the cellular network.

Another existing solution is to provide ‘one size fits all’ kind of control for email activity to suit the typical user. For example, it may be assumed that most users do not require push email during the night. This is however limiting for users, who do not follow normal usage patterns.

One further prior art method is to detect short term usage patterns for bringing all the features to an active state when e.g. the user interface (UI) is accessed.

The problem of the prior art is that this kind of user configuration can be complex and it is not very flexible. If the user misconfigures the settings, the users could experience very poor battery life if e.g. the terminal is performing push email reception through the whole night.

### SUMMARY OF THE INVENTION

The present invention introduces a method for automating feature control on a battery limited device, comprising identifying at least one profile property, where the profile property is a feature of a device or a characteristic of an activity of a device, the profile property having a trend value, which is stored in a memory; updating the trend value for each profile property with latest property data of a predetermined time period, in order to adapt the profile property to the latest activities; and using the updated trend value to control device feature activation or activity levels, to be personalized for the individual user with a minimized battery usage of the device.

According to an embodiment of the invention, the profile property is at least one of the following: User Interface activity, Bluetooth connection success, email fetch success, WLAN connection success, user transmission activity, user reception success, mobility detection, email application usage.

According to an embodiment of the invention, the method further comprises attaching a weighting coefficient to the latest activities before the updating step.

According to an embodiment of the invention, the trend values are initialized to a value disabling power saving when starting the use of or initializing the device.

According to an embodiment of the invention, a high alert state is launched for the device, when the user intends to use the service or when there emerges a deviation compared to a normal behavior, wherein the high alert state triggers disabling the power saving temporarily.

According to an embodiment of the invention, in case of an emerged deviation above a threshold, a large weighting coefficient is set on such a deviation for moving its trend value rapidly towards a value disabling power saving.

According to an embodiment of the invention, the method further comprises combining at least two profile properties by using Boolean operators or by other arithmetic functional operation.

According to an embodiment of the invention, the trend data is set for each daily hour in a calendar week.

Representing another issue of the same invention, a battery limited device configured to have an automated feature control is introduced. The device comprises a controller configured to identify at least one profile property, where the profile property is a feature of a device or a characteristic of an activity of a device, the profile property having a trend value, which is stored in a memory; the controller configured to update the trend value for each profile property with latest property data of a predetermined time period, in order to adapt the profile property to the latest activities; and the controller configured to use the updated trend value in controlling device feature activation or activity levels, to be personalized for the individual user with a minimized battery usage of the device.

According to an embodiment of the device, the profile property is at least one of the following: User Interface activity, Bluetooth connection success, email fetch success, WLAN connection success, User transmission activity, User reception success, mobility detection, email application usage.

According to an embodiment of the device, the controller is further configured to attach a weighting coefficient to the latest activities before the updating step.

According to an embodiment of the device, the controller is further configured to initialize the trend values to a value disabling power saving when starting the use of or initializing the device.

According to an embodiment of the device, the controller is further configured to launch a high alert state for the device, when the user intends to use the service or when there emerges a deviation compared to a normal behavior, wherein the high alert state triggers disabling the power saving temporarily.

According to an embodiment of the device, in case of an emerged deviation above a threshold, the controller is configured to set a large weighting coefficient on such a deviation for moving its trend value rapidly towards a value disabling power saving.

According to an embodiment of the device, the controller is further configured to combine at least two profile properties by using Boolean operators or by other arithmetic functional operation.

According to an embodiment of the device, the trend data is set for each daily hour in a calendar week.

Representing yet a further issue of the same invention, a computer program for automating feature control on a battery limited device is introduced. The computer program comprises code adapted to perform the following steps, when executed on a data-processing system:

identifying at least one profile property, where the profile property is a feature of a device or a characteristic of an activity of a device, the profile property having a trend value, which is stored in a memory;

updating the trend value for each profile property with latest property data of a predetermined time period, in order to adapt the profile property to the latest activities; and

using the updated trend value to control device feature activation or activity levels, to be personalized for the individual user with a minimized battery usage of the device.

According to an embodiment of the computer program, it is stored on a computer readable medium.

### BRIEF DESCRIPTION OF THE DRAWINGS

FIG. 1 illustrates an exemplary email activity trend data for one week,

FIG. 2 illustrates an example of combining email activity and User Interface activity trend data for a single day,

FIG. 3a illustrates trend data collection process according to an embodiment of the invention, and

FIG. 3b illustrates feature control evaluation according to an embodiment of the invention.

### DETAILED DESCRIPTION OF THE EMBODIMENTS

Reference will now be made in detail to the embodiments of the present invention, examples of which are illustrated in the accompanying drawings.

The present invention aims to automate the device operation and to avoid the need for user settings. It should appear for the user that the device services are continuous and available, when they expect them to be, while at the same time achieving good battery life with the procedure.

The present invention is introduced to provide user specific long term profiling for determining when terminal services should be in a high alert state and when power saving schemes can be employed. Furthermore, there are provided methods to quickly adapt to unusual patterns of usage. The present invention removes the need of any user configuration required to improve usability of the battery limited devices.

The invention differs from the known prior art because of the persistent long term profiling and high alert state of the device, when the user is likely desired to use those services, based on history data.

In an embodiment of the invention, a number of profile properties are identified. In other words, we may discuss ‘aspects’ instead of profile properties. These aspects comprise at least one of the following: UI activity, Bluetooth connection success and Email fetch success.

In one embodiment of the invention, for every hour of a calendar week period, a ‘trend’ value for each aspect can be stored in a persistent memory. It is expected that a user pattern cycles every week and an hourly based resolution is suitable. The trend value is used to track a predominant trend for that particular hour. Pseudo code for this storage can be given as in the following example, showing an embodiment of an aspect structure in pseudo code format.

```
{
Aspect_ID
Day [7] // Array of days in weekly cycle
    {
    Hour [24] // Array of hours in a day
        {
      Trend Value //Signed value - eg −127 to +127
  stored as octet.
        }
    }
```

The run time data is captured for each aspect—any positive and negative activity. A weighting is attached to that activity before the trend value is modified.

For example, the ‘Bluetooth connection success’ aspect value will increase with successful connections and decrease when no successful connections are achieved. Similarly for email use, successful reception of email will increase the trend value and no email reception will reduce the trend value. Similar process applies to the UI activity, for example. In the email case, a very high number of received emails would be considered a strong positive activity. A very small number, or none, of received emails, would be considered a strong negative activity.

For safety reasons, the modification of trend values should be biased towards positive values to reduce the risk of poor user experience. For that purpose, the weighting given to the positive and negative changes can be adjusted.

Trend values should be initialised to a value disabling power saving when the phone is new or when it has been restored to initial factory settings. Such an initial setting will ensure a good usability but not necessarily the best battery life. An alternative is to initialise the trend values based on an expected or measured typical (real) user.

Over time the trend values will be adapted to suit different aspects of the device usage personalised to any individual user.

This trend data can then be used to control the device activities and power saving possibilities in different use cases. The different aspects can be used individually or combined with various algorithms. For example, one aspect can be combined with another aspect by applying an ‘AND’ function. Similarly, XOR & OR operations can be applied. While these operators are Boolean in their nature, it can be understood that they could apply to the values, too. For example, the AND operation can be implemented by summing the two values. The OR operation can be considered when either value is above a certain threshold.

Some exemplary use cases:
When should email be “push email” and when should it be “poll email”? What poll value should then be used?

Apply ‘UI activity’ AND ‘Email fetch success’ with function Email_Usecase_Value=((UI_Activity_Trend[currentDay,currentHour]*UI_Activity_Weight)+(Email_Fetch_Success[currentDay,currentHour]*Email_Fetch_Success_Weight)).

If (Email_Usecase_Value>Email_Push_Threshold) then activate push email; else activate poll email.

If poll email active: Email_Poll_Frequency=EmailPollMapFunction(Email_Usecase_Value).
How frequently should the Bluetooth radio scan be performed for the devices?

Apply function Bluetooth_Usecase_Value=(Bluetooth_Success_Trend[currentDay,currentHour]*Bluetooth_Success_Weight).

Bluetooth_Poll_Frequency=BluetoothPollMapFunction(Bluetooth_Usecase_Value).

Another exemplary use case is the scanning frequency for a cellular service. If there was an aspect for mobility, then this procedure can be used to decide the scanning frequency. While it is not new to control scanning frequency depending on mobility detection, the present invention focuses on the long term storage and supervision of that storage. Generally, mobility detection means a procedure, where the device can work out whether it is mobile or static. This can be based on mobility between cellular network cells or detection from a GPS (Global Positioning System) device or by changing signal strength on WiFi cells in the range.

In one embodiment, it is possible to apply a non-linear weighting or mapping if required.

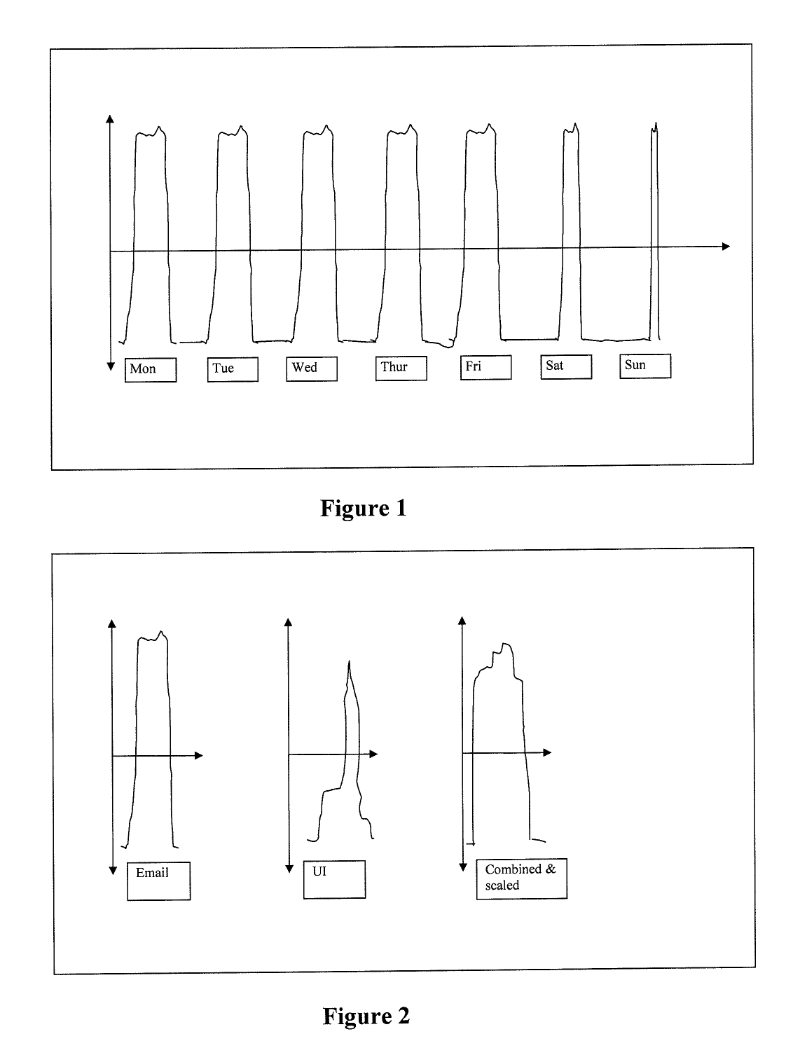

FIG. 1 shows an exemplary trend data for email activity for a single week time period. As can be seen in this example and which is rather common, weekdays are busier regarding email activity than the non-working office days. Also Sunday is less crowded than Saturday, in this example.

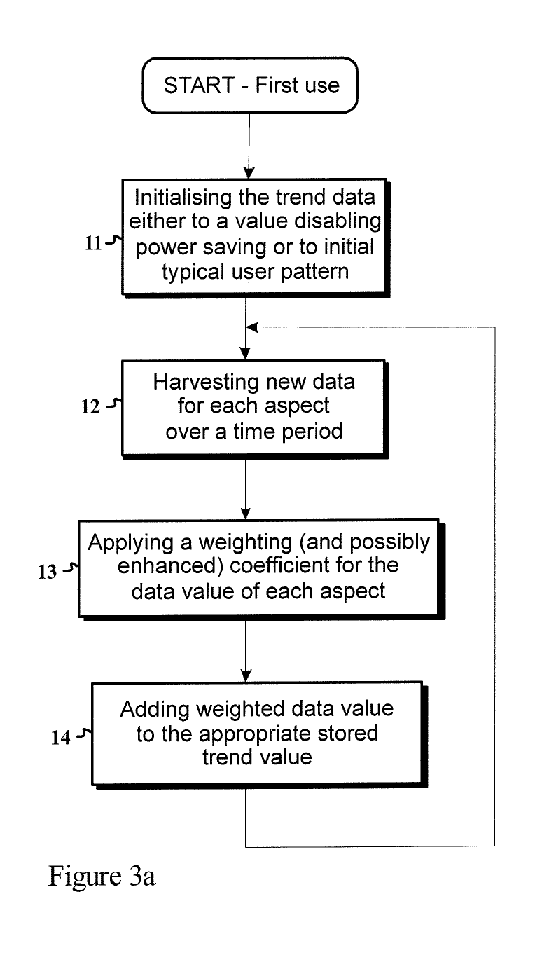

FIG. 2 shows graphs where email activity is shown in the left side, the user interface (UI) activity is shown in the middle and a combined and scaled trend data for a single day is shown in the rightmost chart.

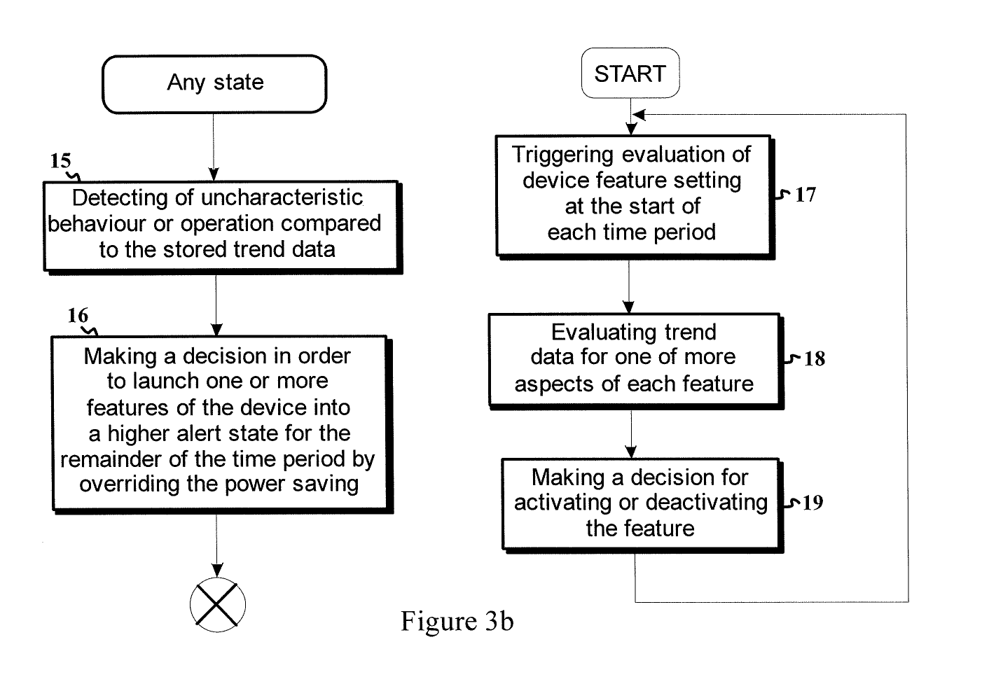

FIG. 3a illustrates an exemplary process of collecting trend data in a form of a flow chart. At the start of the collection process, the trend data is initialised either to a value disabling power saving or to a typical user pattern value 11. After this step, new data is harvested regarding each specified aspect over a one hour period 12. As said earlier, data values for each aspect have a weighting coefficient applied to each of them. An enhanced weighting coefficient may be triggered in case where uncharacteristic behavior or operation is detected 13. After this step, the weighted data value is added to the appropriate trend value stored in the memory 14. The appropriate stored trend value is the value for the current hour in the weekly cycle for the measured aspect.

FIG. 3b illustrates an exemplary process of evaluating feature control in any state after the first use in the form of two flow charts. At first, according to the leftmost chart, the method detects uncharacteristic behavior or operation compared to the trend data stored in the memory 15. After this phase, the method proceeds by making a decision whether to launch one or more features of the device into a higher alert state 16. This is typically performed for the remainder of time period (the time period is e.g. one hour) by overriding the power saving functionality.

Regarding device feature activation, we refer to the rightmost chart of FIG. 3b. At the start of the device feature activation or deactivation procedure, an evaluation of the device feature settings is triggered at the start of each time period 17. In one example, this time period is one hour but it can of course be chosen differently, too. Regarding each feature and at least one aspect of each feature, the trend data is thus evaluated 18. When trend data has been evaluated, the procedure makes a decision for activating a feature, or in a similar fashion, for deactivating a feature 19. If the feature is activated then the setting of that feature may be further evaluated based on trend data. This process cycle 17-19 is repeated at each starting moment of the subsequent time periods, e.g. once an hour.

In the following, any uncharacteristic activity performed by the user is discussed. There can emerge various deviations to the normal activity, for example, travelling at night. The activity of the device can be compared to the trend values corresponding to the current day and hour to detect if there is a strong deviation or difference to the normal behavior of the user. When detecting a strong deviation from normal, various power saving measures can be temporarily disabled and the device can be brought into a high alert state.

In an embodiment, these changes can be adapted so that if these abnormal activities persist at the same time each week, they will be then covered by the normal trend value adaptation as described above. In another embodiment, the changes can be adapted by setting a large weighting coefficient on strong deviations for quickly moving the trend values into a positive direction. If the change does not turn out to be a real trend, the trend values will then reduce with normal handling of trend values according to the above.

Furthermore, in yet another embodiment, adjacent trend values may be examined and considered when choosing the operational state of the device.

A simple example of such a procedure can be implemented as in the following computer program script.

```
Usecase_Value =
  (
    (
    (Trend[currentDay,currentHour-1] * 0.25) +
    (Trend[currentDay,currentHour] * 0.5) +
    (Trend[currentDay,currentHour+1] * 0.25)
    )
  * Weight).
```

Some combination of the data across two sequential days might be needed around midnight but this is omitted for simplicity in this example.

Further aspects can be applied in the present invention to tune the system into even better one. For example, it may be useful to have an aspect for when the email application is used.

The present invention can be easily combined with various prior art battery saving techniques. For example, the long term profiling of the invention can easily be considered along with various short term activity checks according to prior art. These short term activity checks can be fed into adjustments of the trend values.

The advantages of the invention comprise the following. A typical result for a user through applying the invention is that the Bluetooth system will be scanning frequently at times when the users are driving their car with a hands-free system and when in the office, they typically locate near a Bluetooth laptop. Their email will be responsive at times, when they receive most email and also, when they are most likely to be using the device. The battery consumption will typically be at its minimum during night when the device is not likely to be used. Furthermore, the user doesn't need to provide any configuration data and thus, the user experiences good battery life.

The present invention can be implemented in chipsets, devices and operating systems on any devices whose operational lives are limited by batteries. Furthermore, it is possible to implement the present invention in profiling the modem activity in modem platforms.

It is obvious to a person skilled in the art that with the advancement of technology, the basic idea of the invention may be implemented in various ways. The invention and its embodiments are thus not limited to the examples described above; instead, they may vary within the scope of the claims.

1. A method for automating feature control on a battery limited device, comprising:
identifying at least one profile property, where the profile property is a feature of a device or a characteristic of an activity of a device, the profile property having a trend value, which is stored in a memory;
updating the trend value for each profile property with latest property data of a predetermined time period, in order to adapt the profile property to the latest activities; and
using the updated trend value to control device feature activation or activity levels, to be personalized for the individual user with a minimized battery usage of the device.

2. The method according to claim 1, wherein the profile property is at least one of the following: User Interface activity, Bluetooth connection success, email fetch success, WLAN connection success, User transmission activity, User reception success, mobility detection, email application usage.

3. The method according to claim 1, the method further comprising:
attaching a weighting coefficient to the latest activities before the updating step.

4. The method according to claim 1, wherein initializing the trend values to a typical user value or to a value disabling power saving.

5. The method according to claim 1, wherein launching a high alert state for the device, when the user intends to use the service or when there emerges a deviation compared to a normal behavior, wherein the high alert state triggers disabling the power saving temporarily.

6. The method according to claim 5, wherein in case of an emerged deviation is above a threshold, setting a large weighting coefficient on such a deviation for moving its trend value rapidly towards a value where power saving is disabled.

7. The method according to claim 1, further comprising the step of:
combining at least two profile properties by using Boolean operators or by other arithmetic functional operation.

8. A battery limited device, configured to have an automated feature control, the device comprising:
a controller configured to identify at least one profile property, where the profile property is a feature of a device or a characteristic of an activity of a device, the profile property having a trend value, which is stored in a memory;
the controller configured to update the trend value for each profile property with latest property data of a predetermined time period, in order to adapt the profile property to the latest activities; and
the controller configured to use the updated trend value in controlling device feature activation or activity levels, to be personalized for the individual user with a minimized battery usage of the device.

9. The device according to claim 8, wherein the profile property is at least one of the following:
User Interface activity, Bluetooth connection success, email fetch success, WLAN connection success, User transmission activity, User reception success, mobility detection, email application usage.

10. The device according to claim 8, the device further comprising:
the controller configured to attach a weighting coefficient to the latest activities before the updating step.

11. The device according to claim 8, wherein the controller is configured to initialize the trend values to a typical user value or to a value disabling power saving.

12. The device according to claim 8, wherein the controller is configured to launch a high alert state for the device, when the user intends to use the service or when there emerges a deviation compared to a normal behavior, wherein the high alert state triggers disabling the power saving temporarily.

13. The device according to claim 12, wherein in case of an emerged deviation is above a threshold, the controller configured to set a large weighting coefficient on such a deviation for moving its trend value rapidly towards a value where power saving is disabled.

14. The device according to claim 8, further comprising:
the controller configured to combine at least two profile properties by using Boolean operators or by other arithmetic functional operation.

15. A computer program for automating feature control on a battery limited device, the computer program comprising code adapted to perform the following steps, when executed on a data-processing system:
identifying at least one profile property, where the profile property is a feature of a device or a characteristic of an activity of a device, the profile property having a trend value, which is stored in a memory;
updating the trend value for each profile property with latest property data of a predetermined time period, in order to adapt the profile property to the latest activities; and
using the updated trend value to control device feature activation or activity levels, to be personalized for the individual user with a minimized battery usage of the device.

16. The computer program according to claim 15, wherein the computer program is stored on a computer readable medium.
